(19) United States
(12) Patent Application Publication
(10) Pub. No.: US 2010/0095896 A1
(43) Pub. Date: Apr. 22, 2010

(54) REMOTELY-CONTROLLED REWARD DISPENSER FOR ANIMAL TRAINING

(76) Inventor: Mark Van Wye, Los Angeles, CA (US)

Correspondence Address: Mark Van Wye, 8194 Laurelmont Drive, Los Angeles, CA, 90046, US

(21) Appl. No.: 12/603,264

(22) Filed: Oct. 21, 2009

Related U.S. Application Data
(60) Provisional application No. 61/196,802, filed on Oct. 21, 2008.

(51) Int. Cl. A01K 15/02; A01K 15/00; A01K 5/00; A01K 27/00

(52) U.S. Cl. 119/57.92; 221/9; 119/720; 119/719; 221/1

(57) ABSTRACT

A remotely-controlled reward dispenser for animal training includes: a reward dispenser; a wireless receiver; a power source for the dispenser and the receiver; and an attachment mechanism adapted to position the device in proximity to the recipient; wherein, in response to the receiver receiving a wireless signal, the dispenser dispenses the reward in proximity to the recipient, thereby remotely providing the reward to the recipient. A sound generating mechanism may also be included.

### RELATED APPLICATIONS

The present application claims benefit of priority from U.S. Provisional Application No. 61/196,802, filed Oct. 21, 2008, which is incorporated herein by reference in its entirety.

### BACKGROUND OF THE INVENTION

The present invention generally relates to animal training, and more specifically, to a remotely-controlled reward dispenser for animal training.

In the field of animal training, already in wide use are aversive collars that operate remotely to deliver an electrical shock or a burst of citronella spray. For a punitive training approach, these are extremely effective tools for training certain dogs in certain situations with regard to certain types of behavior. However, a vast amount of training can best be accomplished with a positive reinforcement system. Both operant and classic conditioning absolutely depend on the well-timed delivery of rewards in order to be maximally efficacious. Positively rewarding a dog is conventionally accomplished by means of keeping treats in one's pocket or in a pouch and hand-feeding them to the dog at the appropriate time. But there are numerous situations in which distance plays an important role in the behavioral conditioning process; for example, teaching a dog to remain in a down stay while the trainer stands at a distance. As the dog learns to stay in this position for longer durations, this necessitates the trainer crossing the distance and handing a treat to the dog, thus contradicting the independence of the behavior being taught. Furthermore, established research has demonstrated that in order for a dog to be able to associate a reward with a preceding behavior—which is the critical step required to develop and solidify training—the reward must be delivered within 1.6 seconds of the targeted behavior. Intervening distance or even the simple fumbling with treats in one's pocket or pouch causes a delay in this time-critical window, thus rendering the entire training process ineffectual. An ideal solution would be the ability to dispense treats both immediately and remotely. Another important tenet of dog training is that opportunities for teaching one's dog exist throughout the day—good behavior must always be rewarded, and rewarded immediately. If treats were always available instantaneously, at the touch of a button, the efficacy of dog training would increase enormously.

Many dog trainers use clicker training when working with positive reinforcement. In order to solidify the learning of a desired behavior, many trainers end a training session with a “jackpot” —the reward of a large number of treats. Trainers also use jackpots to reward an especially well-executed behavior.

As can be seen, there is a need for a remote-controlled animal training device.

### SUMMARY OF THE INVENTION

In one aspect of the present invention, a device to remotely provide a reward to a recipient includes: a reward dispenser; a wireless receiver; a power source for the dispenser and the receiver; and an attachment mechanism adapted to position the device in proximity to the recipient; wherein, in response to the receiver receiving a wireless signal, the dispenser dispenses the reward in proximity to the recipient, thereby remotely providing the reward to the recipient.

In another aspect of the present invention, a system to train an animal includes: a treat dispenser adapted to be fixed on or near the animal; a wireless receiver to trigger the treat dispenser; and a transmitter to send a signal to the receiver, thereby remotely dispensing a treat to the animal.

In yet another aspect of the present invention, a method of remotely providing a reward to a recipient includes: attaching a reward dispenser in proximity to the recipient; receiving a wireless signal; and dispensing a reward from the reward dispenser, thereby remotely providing the reward to the recipient.

These and other features, aspects and advantages of the present invention will become better understood with reference to the following drawings, description and claims.

### BRIEF DESCRIPTION OF THE DRAWINGS

FIG. 1 depicts a top view of a remote control according to the present invention;

FIG. 2 depicts a side view of a remote control according to the present invention;

FIG. 3 depicts a bottom view of a remote control according to the present invention;

FIG. 4 depicts a front view of a dispenser according to the present invention;

FIG. 5 depicts a side view of a dispenser according to the present invention; and

FIG. 6 depicts a top view of a dispenser according to the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a remotely-controlled treat dispenser, affixable to a collar or other attachment point, with additional audio rewards, for the remote, instantaneous, and portable administration of positive reinforcement animal training.

An embodiment of the present invention may convey to a trainer the ability to administer positive rewards by dispensing treats immediately, remotely, and portably.

An embodiment of the present invention may include a transmitter (a remote control with three buttons) and a receiver (a dispensing unit that performs several functions). A use of the device may be for the positive reinforcement method of animal training, applied remotely. An embodiment can be worn around an animal's neck by affixing it to a collar. From a distance, the trainer may instantaneously perform one of three functions: a) produce a clicking sound (to mark a desired behavior), b) dispense a single treat (to reward a desired behavior), or c) dispense a plethora of treats (to finish a training session or reward an especially well-executed behavior). The device may also be detached from the collar and mounted elsewhere for additional training applications.

Embodiments of the present invention may be relatively small and portable. Embodiments include the active involvement of a trainer, and have audio features. An embodiment allows for a dog to be rewarded at any time, in any location; because the dog carries around his or her own delivery system (i.e. worn around the collar), the core tenets of positive reinforcement animal training are satisfied. Audio features also provide the opportunity for marking desired behaviors. Embodiments avoid requiring either an electric shock or a tightening of the collar or any other such method of positive punishment or compulsion training in order to train a behavior, but instead utilize the desired positive reinforcement method of rewarding behaviors.

In an embodiment of the present invention, the device is worn as a normal dog collar, and has the general appearance of punitive remote collars such as the shock and citronella collar, i.e. the centerpiece is a small form-fitting box. The dispenser may be operated remotely to dispense treats directly from this unit worn around the dog's own neck. The advantage is that the dog always carries his or her own treats, and the handler or trainer need not approach the dog in order to provide rewards.

An embodiment includes a small remote, which is a wireless transmitter with three functional buttons: click, treat and jackpot. As the dispensing apparatus is self-contained, it may be detached from the collar and fixed to a desired location for other training applications. The dispenser may thus be attached to the inside or outside of a cage or kennel, a shelf, one's belt, or any other surface.

An embodiment of the device has a separate button for producing the sound of a clicker. This can be used to mark desired behaviors. By assigning this clicking sound to a separate button, the trainer can elect to create a delay of any desired duration between sounding the clicker and delivering the reward. By incorporating the clicker function, the device obviates the need for a separate device (i.e. a conventional clicker), thus allowing it to be an all-in-one system for positive reinforcement training. The device may also produce a pleasant tone whenever a treat is dispensed, thus adding another element for marking the behavior and the reward.

An embodiment of the device includes a third button assigned to rewarding the dog with a jackpot of treats at the touch of a single button. Both the remote transmitter and the dispenser may be battery-operated. Other than inserting batteries, a trainer's only interaction with the mechanism is refilling the device with treats. If a trainer wishes to empty the device of treats for storage purposes, the jackpot function can be used to easily empty the dispenser. Additional applications of the device are possible, include (but not limited to) remotely dispense food, medicine, or oxygenating tablets into an otherwise hard-to-reach aquarium; to deliver food, medicine or treats to animals within enclosures (i.e. in zoos, pet shops) from a safe distance. The mechanism can be outfitted to work with a range of treats, pills, tablets, capsules, etc. Animals that can benefit from positive reinforcement training are not limited to dogs.

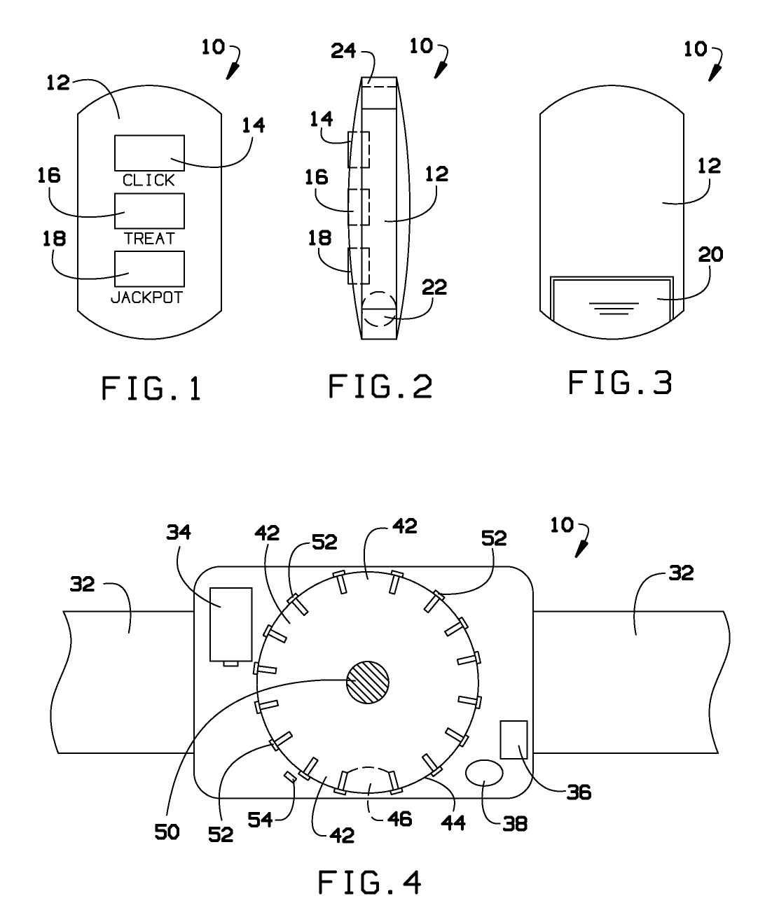

FIGS. 1, 2, and 3 depict an embodiment of a remote control 10, according to the present invention. A molded plastic housing 12 features three buttons: a click button 14 labeled Click, treat button 16 labeled Treat and jackpot button 18 labeled Jackpot. On the back, a battery door 20 gives access for the insertion and changing of the battery 22. The unit also contains a wireless transmitter 24, such but not limited to as radio frequencies (RF) or Bluetooth(R), for relaying one of the three corresponding signals to the receiver unit, as well as necessary wire connections between battery terminals, buttons 14, 16 18, and transmitter 24. Once the user opens the battery door 12, seats a battery 22, and closes the door, the unit is operational. Pressing the click button 14 causes the sound of a clicker to be produced from the receiver unit. Pressing the treat button 16 causes a treat to be dispensed from the receiver unit; simultaneously, this also causes a pleasant tone to sound from the receiver unit. Pressing the jackpot button 18 causes a large number of treats to be dispensed in a constant stream from the receiver unit; simultaneously, this also causes a pleasant tone of longer duration to sound from the receiver unit. The Jackpot function can be used both as a reward during training as well as to flush the receiver unit of treats for storage purposes.

In an alternate embodiment, instead of the clicking sound being relegated to the receiver and triggered remotely and electronically by the remote control, the following alternative is also possible. Instead of the click button being an electronic switch, it can be an actual clicker; i.e., a stiff piece of thin steel or other metal situated in an open space in the remote control. The user presses down on the exposed metal with his thumb, causing the metal sheet to be depressed and distorted; when the user releases his thumb, the metal snaps back into position, causing a clicking sound. In this way, an analog rather than digital clicking sound is produced, and from the remote control rather than the receiving unit. One other possible modification to the design concepts is proposed with regard to the audio cues. The design calls for the receiving unit to produce a pleasant (electronic) tone whenever treats are dispensed. The purpose of this tone is to bring to the dog's attention the fact that a treat has just been dispensed, further strengthening the conditioning efficacy of the reward, and avoiding the potential problem of a dog's not realizing that a treat has been dispensed. It is also possible that the audible sound of the electric servo activating to dispense the treats will be audible to the dog, providing the necessary audio cue without need for the electronic tone. The device therefore can be constructed with or without the tone function.

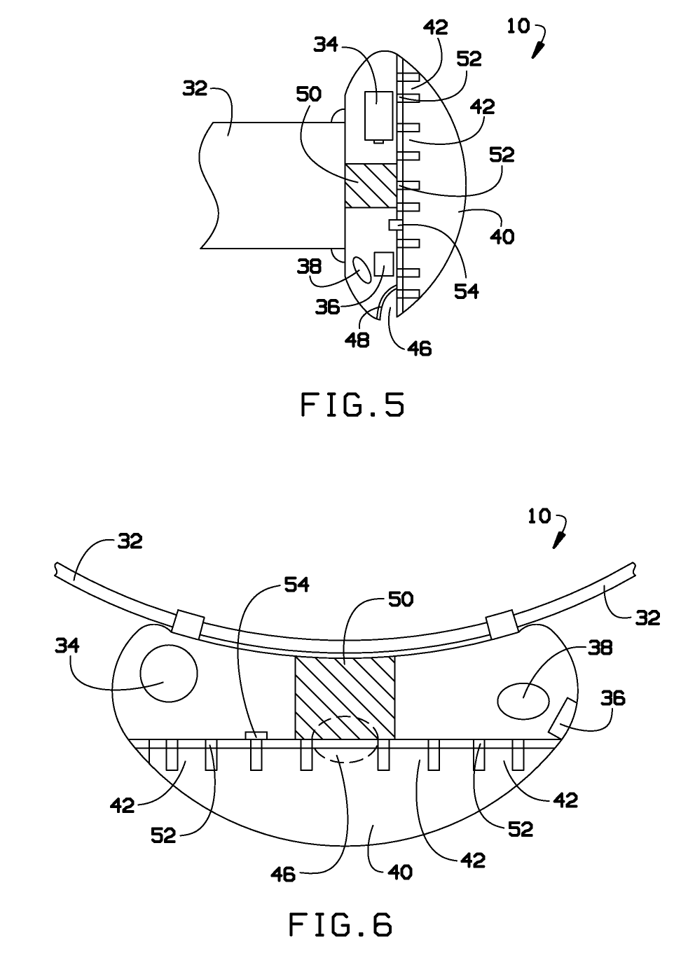

FIGS. 4, 5, and 6 depict an embodiment of a dispenser 30, according to the present invention. The back of the unit has mounting hardware (i.e. loops and snaps) for affixing device to a collar 32 or other surface. A battery door allows access for inserting a battery 34. The device contains a wireless receiver 36, which may be combined or integrated with a microchip for producing sounds from a small speaker 38. A hopper 40 is centralized, with treats able to move freely into equally-spaced wells 42 around the circumference of a central carousel 44. One well 42 is always inaccessible to the central hopper 40—the one located directly over the treat opening 46 at the base of the unit. That one well is shielded above by a small divider 48 that shunts the flow of treats to either side of that well. Each well 42 can accommodate one single treat; surplus piles up in the central hopper 40. An electric servo 50 is centralized to turn the carousel 44 clockwise. The divider of each well 42 extends a microswitch 52; a microswitch terminal contact 54 is located adjacent to the carousel.

In an embodiment, the bottom of the unit features a single opening. The user lifts the hinged hopper door, which is the front of the unit, and fills the central hopper with treats, then closes the lid. The device is then ready to be mounted in the desired location (i.e. attached to a collar and placed around a dog's neck). Gravity causes a few of the treats to fall downward toward the wells. Only one treat will fit in each well; the surplus remains in the central hopper.

In an embodiment, when the click button 14 on the remote control 10 is pressed, a signal is sent to the dispenser 30, which then plays a clicking sound via the speaker 38. When the treat button 16 is pressed, a signal is sent which causes the electric servo 50 to turn clockwise. The servo 50 is attached to the center of the carousel 44. The carousel 44 therefore turns clockwise, until one of the microswitches 52 touches the microswitch contact terminal 54. The placement of the terminal 54 is such that the carousel 44 will stop in the right position, i.e. with one of the wells 42 positioned directly under the small internal divider 48 and over the treat opening 46. Gravity causes the treat to drop from the well 42, through the opening 46, to the ground. As the carousel 44 turns, a fresh supply of treats fills the empty wells 42 from the surplus stored in the central hopper 40. At the same time, a pleasant tone is played from the speaker 38. When the jackpot button 18 is pressed, a signal is sent causing the servo 50 to turn clockwise and ignore a certain number of microswitch 52 contact signals. In doing so, the carousel 44, turned by the servo 50, will continue to turn, thus dispensing a dozen or so treats, one right after another.

In an alternate embodiment, the dispenser houses a stack of three discs that revolve around a central spindle, activated by a remote-controlled servo, these discs being perforated by holes spaced precisely so as to allow the passage of treats from a storage chamber above down through the holes and to an exit at the base of the dispenser.

In an alternate embodiment, the dispenser is fitted with a remotely-controlled hinged trapdoor in it base, which, when activated remotely, lifts to allow the exodus of treats stored in the dispenser. In yet another embodiment, a trapdoor in the base of the dispenser slides horizontally when activated remotely, to allow the exodus of stored treats. In yet another embodiment, the trapdoor in the base of the dispenser is a rotating disc with a single hole, which when activated remotely, rotates via servo to align the hole with an opening in the base of the dispenser to allow the administration of food rewards.

In an alternate embodiment, treats are affixed to a strip of paper tape which is fed in a loop through a jacket, this jacket acting as an animal's collar, and this tape of affixed treats passing through a sprocketed clasp. When this dispenser receives a wireless signal, the sprockets turn, feeding the tape through the clasp, at which juncture one of the affixed treats is leveraged off by an intervening protrusion, resulting in the administration of a food reward.

In an alternate embodiment, the dispenser is limited in size and scope to the function of dispensing the treats and producing the audio cues when a wireless signal is received; the hopper or treat storage function is relegated to a hollow tube, which is worn by an animal as a collar, and which may be encased in fabric or other material. In this embodiment, gravity feeds the treats toward the dispensing apparatus.

It should be understood, of course, that the foregoing relates to exemplary embodiments of the invention and that modifications may be made without departing from the spirit and scope of the invention as set forth in the following claims.

We claim:

1. A device to remotely provide a reward to a recipient, comprising:
a reward dispenser;
a wireless receiver;
a power source for the dispenser and the receiver; and
an attachment mechanism adapted to position the device in proximity to the recipient;
wherein, in response to the receiver receiving a wireless signal, the dispenser dispenses the reward in proximity to the recipient, thereby remotely providing the reward to the recipient.

2. The device of claim 1, wherein the recipient is an animal and the reward is associated with training the animal.

3. The device of claim 1, wherein the attachment mechanism utilizes a collar for an animal.

4. The device of claim 1, wherein the reward includes an edible treat.

5. The device of claim 1, further comprising:
a sound generating mechanism;
wherein the reward includes a sound produced by the sound generating mechanism.

6. The device of claim 1, further comprising:
a container adapted to hold a plurality of treats;
wherein, the dispenser is adapted to dispense a predefined quantity of the treats from the container in response to the wireless signal.

7. The device of claim 6, wherein the dispenser is further adapted to dispense all of the treats remaining in the container in response to a second wireless signal.

8. The device of claim 1, further comprising:
a remote control having a wireless transmitter and an activator;
wherein, in response to operation of the activator, the remote control transmits a wireless signal to the wireless receiver, and the device provides the reward.

9. The device of claim 8, wherein the remote control includes a sound generating mechanism and the reward includes a sound generated by the sound generating mechanism.

10. The device of claim 8, wherein the activator is a button on the remote control.

11. A system to train an animal, comprising:
a treat dispenser adapted to be fixed on or near the animal;
a wireless receiver to trigger the treat dispenser; and
a transmitter to send a signal to the receiver, thereby remotely dispensing a treat to the animal.

12. The system of claim 11, further comprising:
a sound generating mechanism;
wherein the wireless receiver triggers the sound generating in response to a second signal from the transmitter.

13. The system of claim 11, further comprising:
a container adapted to hold a plurality of treats;
wherein the dispenser dispenses one of the treats in response to a first signal; and
the dispenser dispenses the all treats in the container in response to a second signal.

14. A method of remotely providing a reward to a recipient, comprising:
attaching a reward dispenser in proximity to the recipient;
receiving a wireless signal; and
dispensing a reward from the reward dispenser, thereby remotely providing the reward to the recipient.

15. The method of claim 14, wherein the recipient is an animal, and the reward is a treat for the animal, the method further comprising:
receiving a second wireless signal; and
providing an audible signal to the animal;
thereby assisting in remote training of the animal.
